(19) United States
(12) Patent Application Publication
(10) Pub. No.: US 2009/0225327 A1
(43) Pub. Date: Sep. 10, 2009

(54) POSITION MEASUREMENT APPARATUS, POSITION MEASUREMENT METHOD, AND EXPOSURE APPARATUS

(75) Inventor: Kohei Maeda, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/398,797

(22) Filed: Mar. 5, 2009

(30) Foreign Application Priority Data
Mar. 5, 2008 (JP) 2008-054950

(51) Int. Cl. G01B 11/00; G01B 9/02

(52) U.S. Cl. 356/496

(57) ABSTRACT

A position measurement apparatus includes a first beam splitter configured to split light from a light source into reference light and measurement light, a reference mirror configured to receive the reference light and a second beam splitter configured to synthesize the reference light reflected on the reference mirror with the measurement light that enters and is reflected on an object to be measured. The position measurement apparatus drives an object to be measured through a driving mechanism, detects the interference pattern through a photoelectric conversion element, and calculates a surface position of the object to be measured based on a change of a detection signal obtained from the interference pattern. The position measurement apparatus further includes a selector configured to select a signal from an interference area between reflected measurement light and reflected reference light.

### BACKGROUND OF THE INVENTION

1. Field of the Invention

The present invention relates to a position measurement apparatus, a position measurement method, and an exposure apparatus that has the position measurement apparatus.

2. Description of the Related Art

A projection exposure apparatus is conventionally used to expose a pattern of a reticle (mask) onto a substrate via a projection optical system, and a highly accurate alignment of a wafer surface with an exposure imaging position is increasingly demanded for a finer exposure. For example, a step-and-scan type exposure apparatus (also referred to as a “scanner”) needs to control a tilt of the wafer surface as well as a height (focus) of the wafer surface in a direction perpendicular to a scanning direction. Many methods are proposed for measuring and controlling the focus and tilt of the wafer surface position by setting a plurality of measurement points in the exposure slit area. Japanese Patent Laid-Open No. (“JP”) 6-260391 and U.S. Pat. No. 6,249,351 propose a method of using an optical sensor as a method of measuring a wafer surface position.

Other prior art include Japanese Domestic Publication No. 2006-514744 and a method of using a capacitance sensor.

Due to the recent trend of using exposure light of a smaller wavelength and a projection optical system having a higher NA, a depth of focus becomes extremely small, and so-called focus accuracy that is accuracy with which the wafer surface to be exposed is positioned to the best imaging surface becomes increasingly severer. For instance, the method of JP 6-260391 in the prior art cannot precisely detect a wafer surface position due to a thin film interference in the resist of the wafer. Accordingly, a surface position detection method calls attentions, which utilizes an interference signal of an oblique incidence method, as disclosed in U.S. Pat. No. 6,249,351. As shown in FIG. 1, this detection method splits broadband light from a light source 1 into reference light R and measurement light M through a beam splitter 5a, and introduces the reference light R to a reference mirror 7 and the measurement light M to a surface of the object 6 to be measured. Then, this method again synthesizes the respective reflected luminous fluxes through a beam splitter 5b, and detects an interference pattern. This method obtains a surface shape from changes in the detection signal for each driving of the object to be measured.

This method can shorten a coherence distance by using the broadband light, and can set a measurement range more widely than that of the monochromatic light. In addition, it has an advantage in reducing an error that would otherwise be caused by the interference of the detection light in the resist film.

However, when this detection method detects the surface position of the object to be measured, the reference light R is reflected on the reference mirror surface 7 and then is received by the detector 14 without a positional change, whereas a position of the measurement light M received by the detector 14 changes because the surface position of the object to be measured is changed whenever it is driven. As a result, an area of the reference light R and an area of the measurement light M on a light receiving element on the detector are separated into an interference area I and a noninterference area N (FIG. 2). In FIG. 2, D denotes a shift direction of the measurement light M when a surface to be measured is moved in the Z direction.

As a ratio of the noninterference area N contained in the light receiving element of the detector 14 increases, the contrast of the position detection signal that is obtained by driving the object to be measured tends to lower. The measurement accuracy degrades as the contrast drops. More specifically, FIG. 2 shows the reference light R and the measurement light M on the sensor when the object to be measured shown in FIG. 1 is located at a position of Z=Z0 and at a position of Z=Z1. At Z=Z0, the reference light R and the measurement light M are located at the same position and only the interference signal is obtained. A curve “a” in a graph of FIG. 3 denotes an interferogram when a position of the object to be measured is changed and only the above interference signal is received by the light receiving element. The curve “a” is an interferogram having an envelope peak at the position of Z=Z0. However, when a position of a plane to be measured is changed in the oblique incidence type interferometer, a position of the measurement light M shifts from a position of the reference light R, thus the interference area I reduces in the light receiving element and the noninterference area N expands. A curve “b” in the graph of FIG. 3 denotes an interferogram detected in the light receiving element in the detector at that time.

When the curves “a” and “b” are compared with each other, the contrast of the curve “a” is better because the light is limited to the light from the interference area I and the light from the noninterference area N which would become a noise component is eliminated. Since the improvement of the contrast leads to the improvement of the positional measurement accuracy, it is necessary to reduce a component of the noninterference area N during detections.

### SUMMARY OF THE INVENTION

The present invention provides a position measurement apparatus that can precisely measure a surface position without dropping the contrast of a detection signal, and an exposure apparatus having the same.

A position measurement apparatus according to one aspect of the present invention includes a first beam splitter configured to split light from a light source into reference light and measurement light, a reference mirror configured to receive the reference light, a second beam splitter configured to synthesize the reference light reflected on the reference mirror with the measurement light that enters and is reflected on an object to be measured, a photoelectric conversion element configured to detect an interference pattern caused by interference between the reference light and the measurement light that are synthesized, a driving mechanism configured to drive the object to be measured, the position measurement apparatus being configured to drive the object to be measured through the driving mechanism, to detect the interference pattern through the photoelectric conversion element, and to calculate a surface position of the object to be measured based on a change of a detection signal obtained from the interference pattern, and a selector configured to select a signal from an interference area between reflected measurement light and reflected reference light.

A position measurement method according to another aspect of the present invention includes the steps of splitting light from a light source into reference light and measurement light, introducing the reference light to a reference mirror, introducing the measurement light to an object to be measured, synthesizing the reference light reflected on the reference mirror with the measurement light that enters and is reflected on the object to be measured, detecting, via a photoelectric conversion element, an interference pattern caused by interference between the reference light and the measurement light that are synthesized while driving the object to be measured, calculating a surface position of the object to be measured based on a change of a detection signal obtained from the interference pattern, and selecting a signal from an interference area between reflected measurement light and reflected reference light.

An exposure apparatus according to another aspect of the present invention includes the above position measurement apparatus.

Further features of the present invention will become apparent from the following description of exemplary embodiments with reference to the attached drawings.

### BRIEF DESCRIPTION OF THE DRAWINGS

FIG. 1 is a view showing a position measurement principle according to one aspect of the present invention.

FIG. 2 is a view showing a two-dimensional interference signal detected by an image sensor according to the present invention.

FIG. 3 is a view showing an interferogram according to the present invention.

FIG. 4 is a view showing a structure of a position measurement apparatus according to first to third embodiments of the present invention.

FIG. 5 is a view showing an interferogram obtained by the embodiments of the present invention.

FIG. 6 is a partially enlarged view of the position measurement apparatus according to the embodiments of the present invention.

FIG. 7 is a view showing an interference signal between the reference light R and the measurement light M in the image sensor according to the embodiments of the present invention.

FIG. 8 is a view showing an interferogram according to the present invention.

FIGS. 9A to 9C are views each showing a transmission slit board provided before the image sensor according to the first embodiment of the present invention.

FIG. 10 is a view showing a signal after the noninterference signal is removed according to the first embodiment of the present invention.

FIGS. 11A to 11C are views each showing that only the interference signal is detected as an electric signal in the image sensor according to the second embodiment of the present invention.

FIG. 12 is a view showing that a one-dimensional image sensor detects only an interference signal according to the third embodiment of the present invention.

FIG. 13 is a view showing a structure of an exposure apparatus according to a fourth embodiment of the present invention.

FIG. 14 is a view showing a surface position measurement apparatus according to the fourth embodiment.

FIG. 15 is a view for explaining a calibration method according to the fourth embodiment.

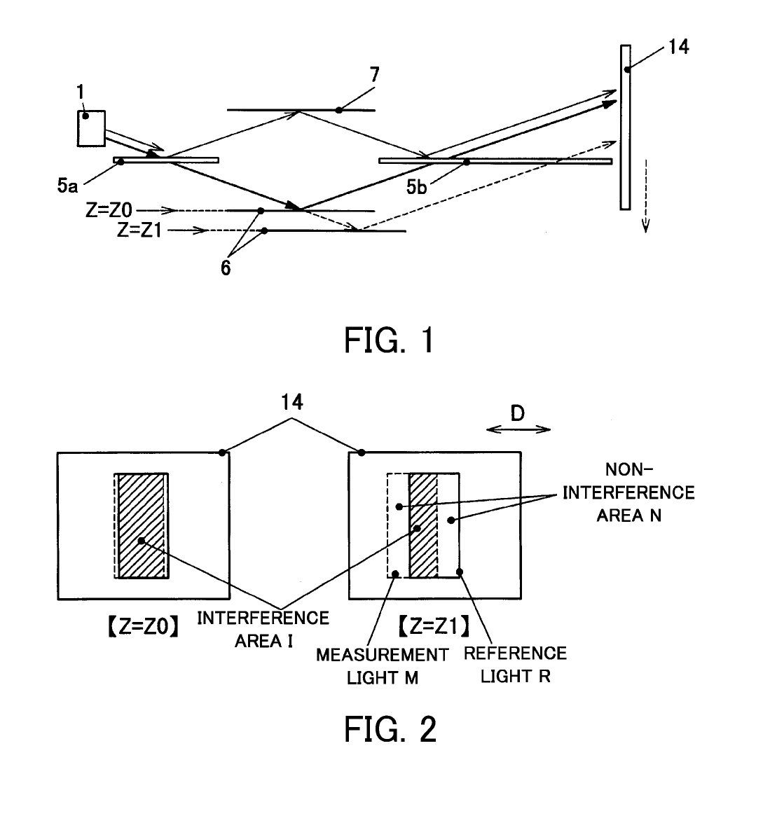

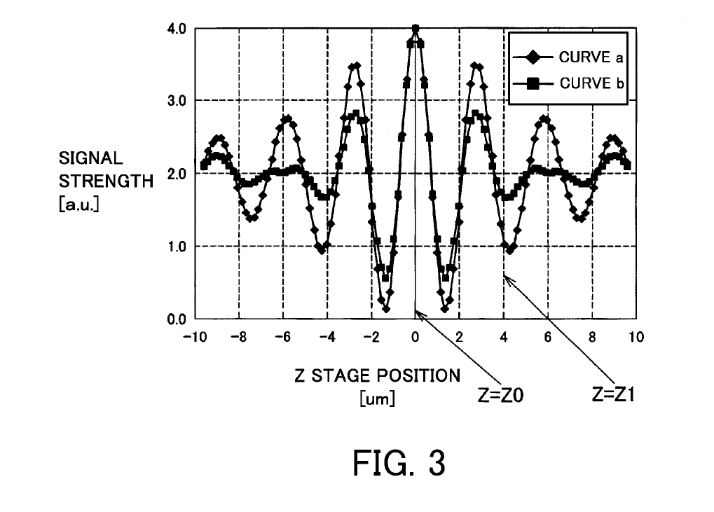

### DESCRIPTION OF THE EMBODIMENTS

Referring now to the accompanying drawings, a description will be given of embodiments of the present invention. The same element in each figure is designated by the same reference numeral, and a duplicate description thereof will be omitted.

### First Embodiment

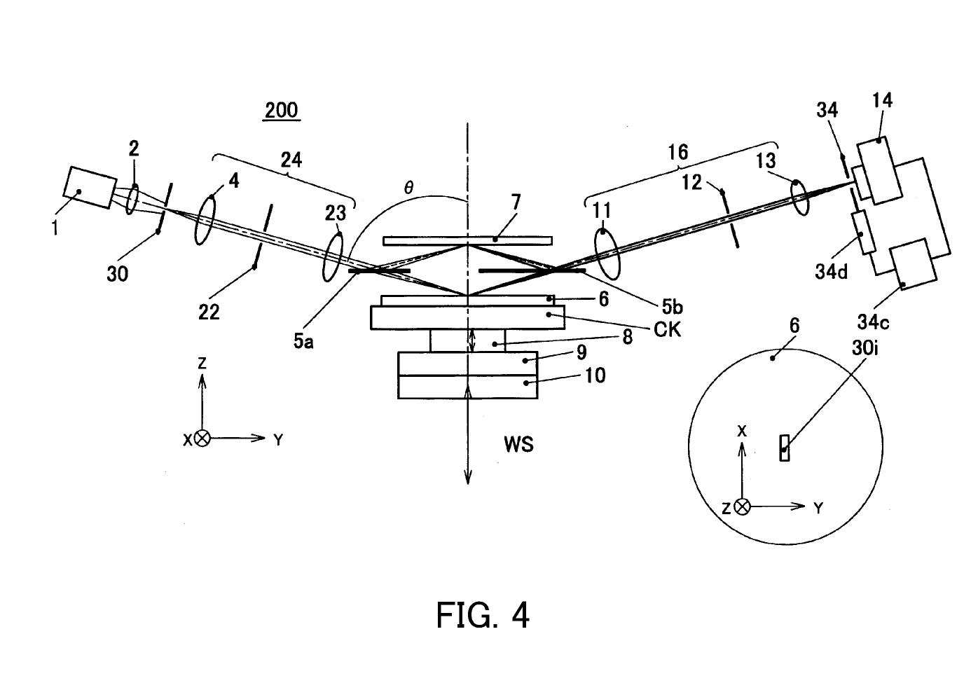

FIG. 4 is a schematic view showing a structure of a position measurement apparatus 200 as one aspect of the present invention. A position measurement apparatus 200 is an apparatus configured to detect a surface position of a substrate 6 as a measurement object (object to be measured) in the Z direction. The position measurement apparatus 200 includes a light source 1 as an LED (including so-called a white LED) or a halogen lamp, which emits the light having a broadband wavelength width, a condenser lens 2 configured to condense the emitted light, a slit board 30, an imaging optical system 24 that includes a lens 4 and a lens 23, an aperture stop 22, and a (first) beam splitter 5a configured to split the light. The position measurement apparatus 200 further includes a substrate chuck CK configured to hold a substrate 6 as the measurement object, a driving mechanism (a Z stage 8, a Y stage 9, and an X stage 10) used for an alignment with the measurement object, a reference mirror 7, a (second) beam splitter 5b configured to synthesize the light reflected on the reference mirror 7 with the light reflected on the substrate 6, an image sensor 14 (photoelectric conversion element) 14, such as a CCD and a CMOS, an imaging optical system 16 that includes a lens 11 and a lens 13 and forms an image of the surface of the substrate 6 onto the image sensor 14, an aperture stop 12, and a slit board 34.

Next follows a detailed description of a function of each component and embodiments. In FIG. 4, the light emitted from the light source 1 is condensed on the slit board 30 by the condenser lens 2. The slit board 30 has a rectangular or circular passage area or a mechanical stop so as to form an image of a rectangular or circular image on the substrate 6 and the reference mirror 7 through the imaging optical system 24. A principal ray of the light that has passed the imaging optical system 24 enters the substrate 6 at an incident angle θ. Since the beam splitter 5a is provided on the optical path, the light having an approximately half the light quantity is reflected on the beam splitter 5a, and enters the reference mirror 7 at the same incident angle θ as that for the substrate 6.

Here, the light source 1 may have a wavelength band from 400 nm to 800 nm. However, the wavelength band is not limited to this range, and may be a band of 100 nm or higher; when the resist is applied to the substrate 6, the light having a wavelength of 350 nm (the ultraviolet) or smaller may not be irradiated onto the substrate 6 so as to prevent the exposure of the resist. The light polarization state is set to a non-polarization or a circular polarization. As the incident angle θ upon the substrate increases, the reflective index from the surface of the thin film (such as the resist) on the substrate 6 becomes higher relative to the reflective index from the back surface of resist (or an interface between the resist and the substrate). Hence, a high incident angle θ is suitable in measuring a surface position of the thin film. On the other hand, the incident angle from 70° to 85° is suitable for the embodiment because an assembly of the optical system becomes difficult as the incident angle θ is close to 90°.

The beam splitter 5a can use a cubic type beam splitter that uses a metallic film or a dielectric multilayer film as a splitting film, or a pellicle type beam splitter that includes a thin film having a thickness of about 1 μm to about 5 μm (which is made of SiC, SiN, or the like).

The light that has transmitted the beam splitter 5a is irradiated onto the substrate 6, and enters the beam splitter 5b after it is reflected on the substrate 6 (the light reflected on the substrate 6 will be referred to as measurement light M). On the other hand, the light reflected on the beam splitter 5a is irradiated on the reference mirror 7, and enters the beam splitter 5b after it is reflected on the reference mirror 7 (the light reflected on the reference mirror 7 will be referred to as reference light R). The reference mirror 7 can use an aluminum plane mirror having a surface precision from about 10 nm to about 20 nm, or a glass plane mirror having a similar surface precision.

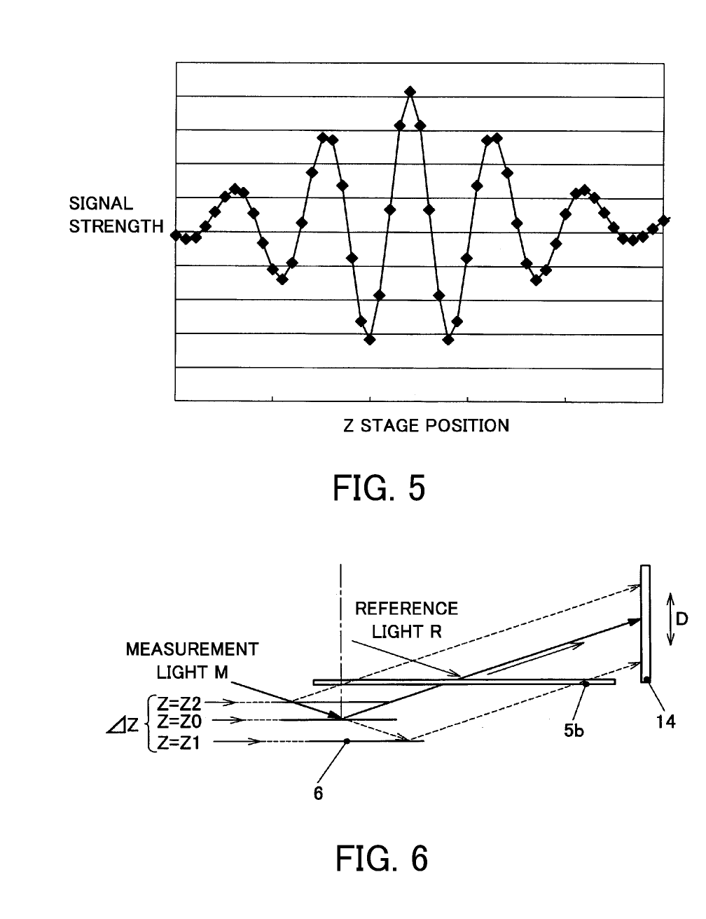

The measurement light M reflected on the substrate 6 and the reference light R reflected on the reference mirror 7 are synthesized by the beam splitter 5b, and the resultant light is received by the image sensors 14 (or the light receiving element). The beam splitter 5b can use the same as one for the beam splitter 5a. The lenses 11 and 13 and aperture stop 12 are arranged on the optical path; the lenses 11 and 13 form the double-sided telecentric imaging optical system 16 and the surface of the substrate 6 can be imaged on a light receiving surface of the image sensor 14. Thus, this embodiment forms an image of the slit board 30 on the substrate 6 and the reference mirror 7 via the imaging optical system 24, and then on a light receiving surface of the image sensor 14 via the imaging optical system 16. The aperture stop 12 arranged at a pupil position of the imaging optical system 16 is provided to determine a numerical aperture (“NA”) of the imaging optical system 16, and the NA is limited to such a very small NA as about sin(0.5°) to about sin(5°). The slit board 34 having a variable slit opening width, and a controller 34c and a driver 34d configured to control the slit part's size are provided in front of the image sensor 14. The measurement light M and the reference light R are superposed on the light receiving surface of the image sensor 14, forming the light interference (interference light). The slit board 34 can change and limit the area of the light incident upon the sensor. Next follows a description of a method of acquiring an interference signal that is an important point of the present invention. In FIG. 4, the substrate 6 is held by the substrate chuck CK, and set up on the Z stage 8, the Y stage 9, and the X stage 10. The Z stage 8 is driven in order to obtain a white interference signal shown in FIG. 5 with the image sensor 14. The light intensity of each pixel of image sensor 14 corresponding to a reflection point on the substrate 6 is stored in a memory (not shown). In changing a measurement area on the substrate 6, the above measurement is performed after a desired area is aligned with the light receiving area on the image sensor 14 by using the X stage 10 or the Y stage 9. Although not shown in FIG. 4, a plurality of laser interferometers are provided for five axes including the X, Y, and Z axes and the tilt axes ωy and ωy in order to precisely control the positions of the X stage 10, the Y stage 9, and the Z stage 8. The accuracy of the positional measurement can be improved when the closed loop control is provided based on the output of the laser interferometer. When it is necessary to divide the substrate 6 into a plurality of areas and to provide a global positional measurement of the entire substrate 6, use of the laser interferometer is an effective structure because shape data can be more precisely stitched.

Next follows a description of a method of calculating a position of the substrate 6 by processing a white interference signal obtained by the image sensor 14 and stored in the memory. FIG. 5 shows a white interference signal in a certain pixel in the image sensor 14. Here, the image sensor 14 exemplarily uses a two-dimensional image sensor. This white interference signal is also referred to as an interferogram where an abscissa axis denotes a measurement value of the Z-directional position of the Z-axis laser interferometer (although the measurement sensor may be a capacitance sensor) after the Z-axis stage is driven, and an ordinate axis denotes an output of the image sensor 14. The envelope peak position of the white interference signal is calculated, and a corresponding measurement value of the Z-axis laser interferometer is a height measurement value in that pixel. The three-dimensional shape of the substrate 6 can be measured by measuring a height at each pixel in the surface of the image sensor 14. One method of calculating an envelope peak position is to form an approximate curve (such as a quadratic curve) based on data on the envelope peak position and several points before and after it and to calculate a peak position with a resolution of about 1/10 to about 1/50 as large as the sampling pitch Zp of the Z axis that is an abscissa axis in FIG. 5. For the sampling pitch Zp, a method of stepwise driving at an equal pitch of the actual Zp may be used but an output (Z position) of the Z-axis laser interferometer may be obtained in synchronization with the taking timing of the image sensor 14 for expedited processing.

A method of measuring a peak position may use an FDA (U.S. Pat. No. 5,398,113) that is a well-known technology. The FDA method calculates a peak position of the contrast by using a phase gradient of the Fourier spectrum.

Thus, in the white interference method, the resolution and accuracy depend upon the precision of calculating a position that provides a difference of the optical path length of 0 between the reference light R and the measurement light M. Therefore, some fringe analysis methods are proposed as well-known technologies, such as a method of calculating an envelope of the white interference pattern by the phase shift method or the Fourier transformation method other than the FDA method, and of calculating a zero point of the optical path difference from the maximum position of the fringe contrast, or a phase cross method.

Referring now to FIG. 6, an effect of the present invention will be described.

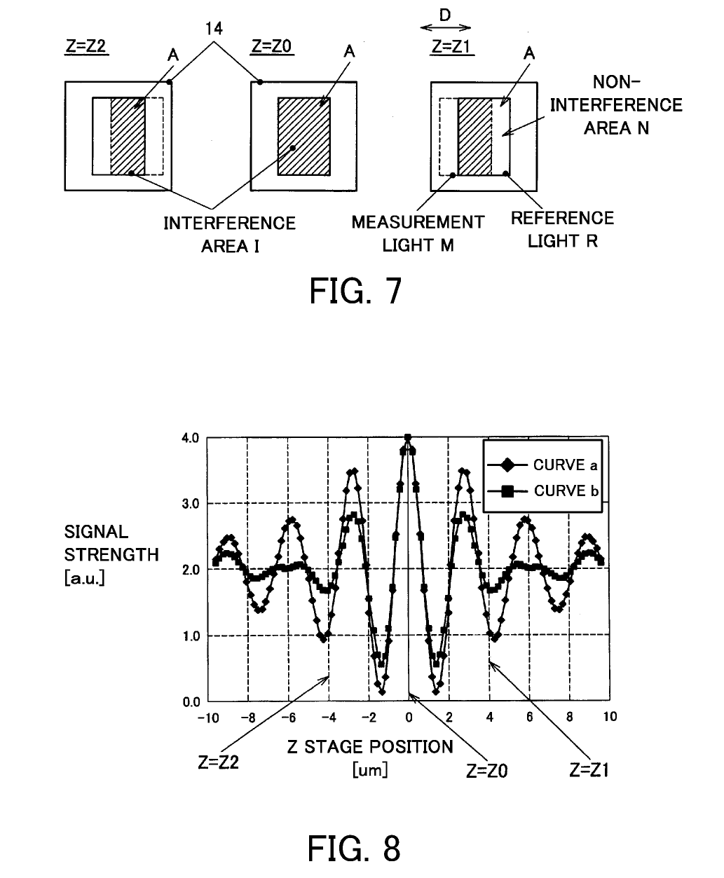

FIG. 7 shows a positional relationship between the measurement light M and the reference light R on the image sensor 14 in the normal oblique incidence type interferometer when Z positions of the plane to be measured are Z0, Z1, and Z2. At Z=Z0, the measurement light M is located at the same position as that of the reference light R; at Z=Z1 or Z2, a position of the object to be measured shifts, the optical axes of the reference light R and the measurement light M shift, and the position of measurement light M shifts.

As a result, the interference area I between the reference light R and the measurement light M on the image sensor 14 becomes maximum at the position of Z=Z0, and the interference area I reduces and the noninterference area N expands as the Z position changes to Z1 or Z2.

A curve “a” in the graph of FIG. 8 shows an intensity variation (interferogram) at a certain pixel position A in the interference area I for each Z position. The envelope peak position in this curve is calculated, and a corresponding measurement value of the Z-axis laser interferometer becomes a height measurement value in that pixel. A three-dimensional shape can be measured by performing the above procedure for each pixel in the surface of the image sensor 4.

However, as shown in FIG. 7, when the Z position of the object to be measured is changed in order of Z2, Z0 and Z1, the two-dimensional signal in the image sensor has both the interference area I and the noninterference area N. This configuration provides an interferogram where signals from the interference area I and the noninterference area N are mixed according to the Z position of the object to be measured at the pixel position A. In that case, the signal from the noninterference area N becomes a noise and lowers the contrast of the interferogram. The deteriorated contrast of the interferogram lowers the accuracy for calculating the envelope and the signal peak by using the above FDA method, the phase shift method, or the Fourier transformation method, and consequently degrades the positional measurement accuracy.

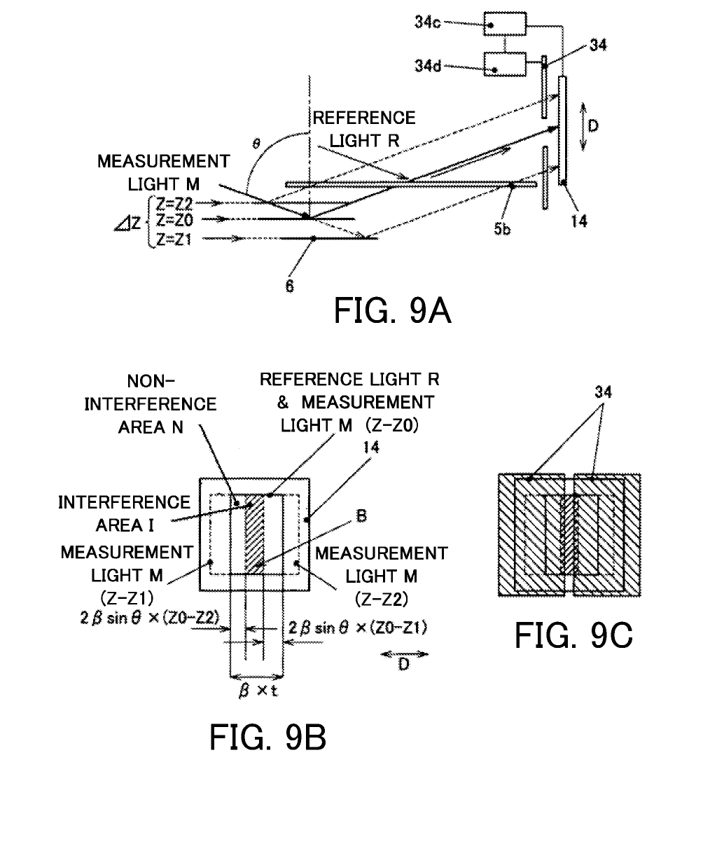

Accordingly, in order to remove the noninterference area N that causes a noise in the image sensor 14, the slit board 34 shown in FIG. 9A is arranged in front of the image sensor 14. This slit board 34 is connected with the controller 34c and the driver 34d, and an area of the light incident upon the image sensor 14 can be changed and limited. For instance, assume that θ is an oblique incident angle, “t” is a slit width of the slit board 34, β is an optical magnification from the slit board 34 to the detector (image sensor 14), and ΔZ is a driving or measurement range of the object to be measured (substrate 6) from Z1 to Z2. However, a slit width direction in the detector 14 is the same as a positional shift direction of the measurement light by ΔZ. An area L can be expressed as follows, which is always the interference area I at the detector 14 in the driving range of the object to be measured (FIG. 9B):

L=β×t−2β sin θ×[(Z0−Z1)−(Z0−Z2)]=β×t−2β sin θ×(Z2−Z1)=β×(t−2 sin θ×ΔZ) EQUATION 1

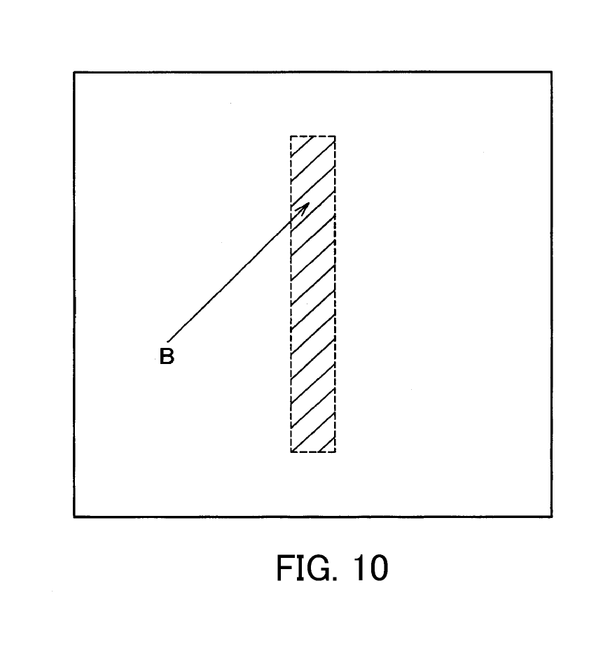

By setting the slit width of the slit board 34 smaller than the above area L (FIGS. 9B and 9C), only the signal from the interference area I can be received in the driving range of the object to be measured (FIG. 10).

At this state, the interferogram at a pixel position B in the interference area I becomes the curve “a” in the graph in FIG. 8. When it is compared with the curve “b,” it is understood that the noise component decreases and the contrast improves. The slit board 34, as used herein, is a slit having a fixed slit aperture, and may be a transmission slit or a mechanical slit. In addition, the detector 14 may use a two-dimensional light receiving element. A slit center position of the slit board 34 having a width determined by the above equation is arranged so that it corresponds to the center position of the reference light R.

### Second Embodiment

Next follows a description of a second embodiment according to the present invention about its differences from the first embodiment.

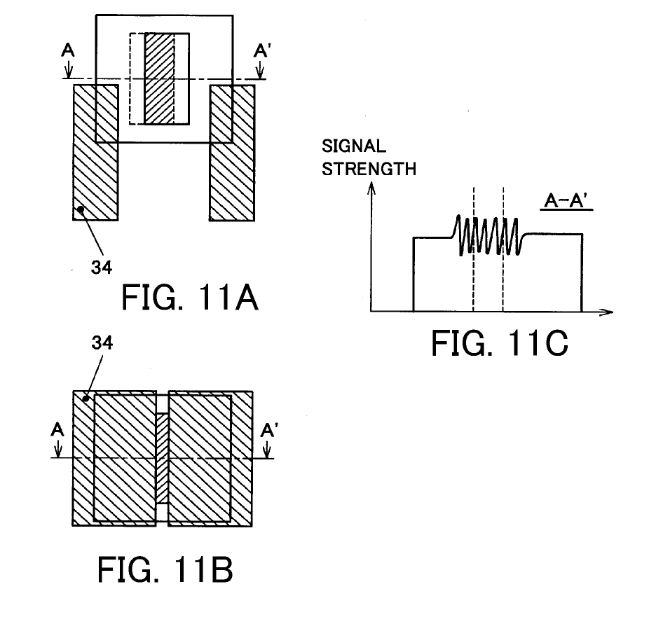

A method of removing the noninterference area N will be described with reference to FIG. 11. The interference area I and the noninterference area N between the reference light R and the measurement light M on the image sensor 14 are electrically detected (FIG. 11A), and the detection effective area is determined (interference area I searching function) (FIG. 11B).

More specifically, in detecting the two-dimensional signals from the reference light and the measurement light M on the image sensor, the intensity of the A-A′ section becomes as shown in FIG. 11C.

The controller 1100, which will be described later, calculates the interference and noninterference pixel areas from the detection result of the image sensor 14, selects readout start and end positions of the image sensor 14, cuts the noninterference area N, and obtains the intensity signal from only the interference area I. Alternatively, information is sent from the image sensor 14 to the shape controller 34c for the slit board 34 and the shape of the transmission slit may be controlled so that the light from only the interference area I detected by the image sensor 14 can transmit. When the control means for selecting the interference area I is provided, the image sensor 14 receives the light from only the interference area I and the light from the noninterference area N that becomes a noise is removed. When the expedited processing is emphasized, the interference area I between the reference light R and the measurement light M indicated by the equation in the first embodiment may be previously calculated, and the pixels only in that area may be electrically selected or the slit board 34 may be limited.

### Third Embodiment

In addition to the first and second embodiments, a method of removing the noninterference area N from the detector 14 may use a small image sensor or light receiving element configured to always receive the light only from the interference area I in the measurement range of the object to be measured.

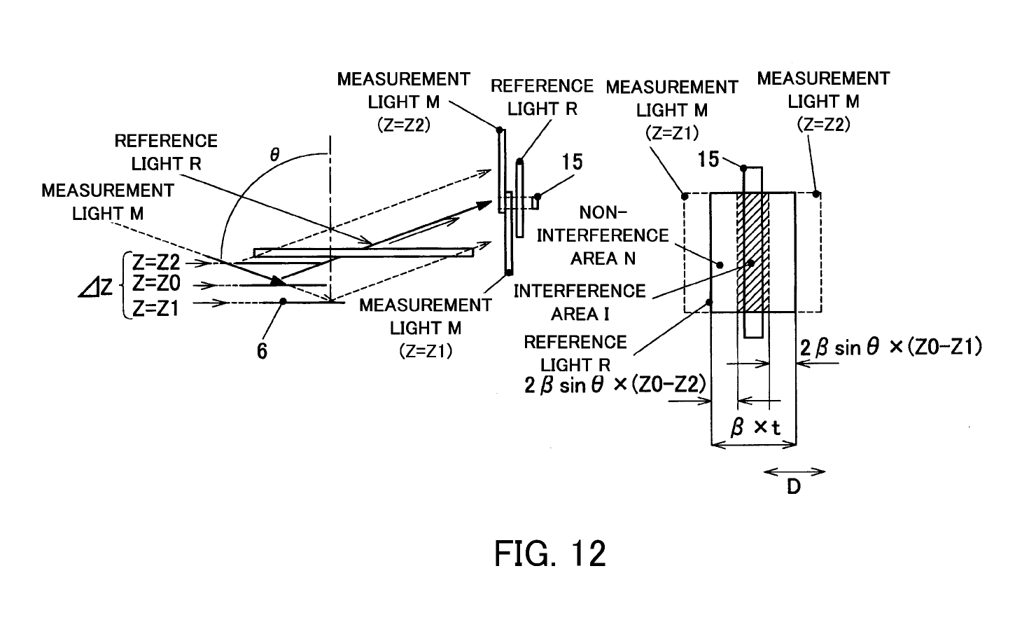

For instance, a one-dimensional image sensor 15 smaller than the interference area I may be used so as to always receive the light only from the interference area I in the measurement range of the object to be measured, based on FIG. 12 and the equation in the first embodiment. In this case, when the Z position of the object to be measured changes from Z0 to Z1 or Z2 and the position of the measurement light M is changed, the one-dimensional image sensor 15 always receives the light from the interference area I even when the interference area I changes and the light from the noninterference area N that becomes a noise is removed. The arrangement center of the one-dimensional image sensor 15 may be the center of the reference light R.

### Fourth Embodiment

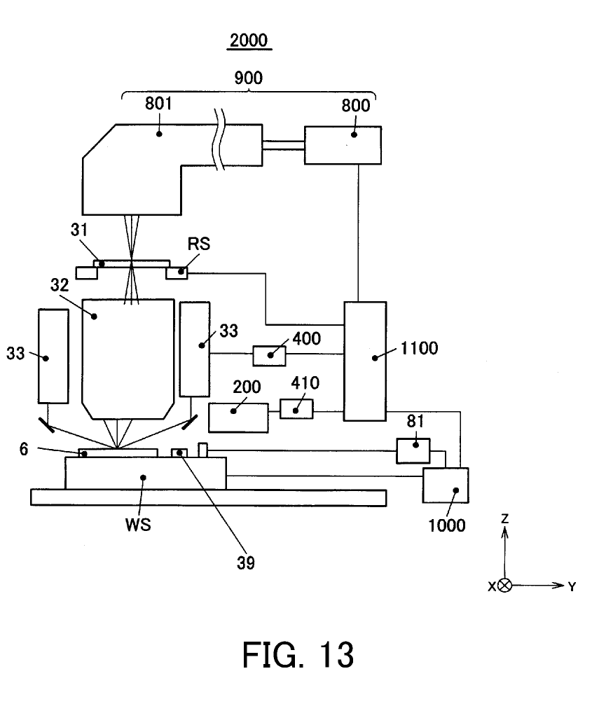

FIG. 13 is a block diagram of a semiconductor exposure apparatus 2000 that includes the position measurement apparatus of the present invention. The exposure apparatus 2000 of the present invention includes an illumination apparatus 900, a reticle stage RS configured to support a reticle (original) 31, a projection optical system 32, a wafer stage WS configured to support a wafer (substrate) 6, a focus control sensor 33, and a position measurement apparatus 200. A reference plate 39 is arranged on the wafer stage WS. The exposure apparatus 2000 further includes an operation processor 400 for the focus control sensor 33, and an operation processor 410 for the position measurement apparatus 200. While this embodiment uses a step-and-scan type exposure apparatus (also referred to as a “scanner”), but the present invention is not limited to this type and may use a step-and-repeat type exposure apparatus (also referred to as a “stepper”).

The position measurement apparatus 200 can use any one of the first to third embodiments. While both the focus control sensor 33 and the position measurement apparatus 200 serve to measure a position of the substrate 6, and has the following characteristics. The focus control sensor 33 has a high responsiveness but is subject to cheating of a wafer pattern. The position measurement apparatus 200 is a sensor that has a low responsiveness but is less likely to be cheated by a wafer pattern.

The controllers 1100 and 1000 have a CPU and a memory, are electrically connected to the illumination apparatus 900, the reticle stage RS, the wafer stage WS, the focus control sensor 33, the position measurement apparatus 200, and the laser interferometer 81, and control an operation of the exposure apparatus 2000. When the focus control sensor 33 detects a surface position of the wafer 6, the controller 1100 of this embodiment correctively operates a measurement value and provides controls.

The illumination apparatus 900 illuminates a reticle 31 that has a circuit pattern to be transferred, and includes a light source part 800 and an illumination optical system 801.

The light source part 800 uses, for instance, a laser. The laser can use an ArF excimer laser having a wavelength about 193 nm, and a KrF excimer laser having a wavelength about 248 nm. However, a type of the light source is not limited to an excimer laser, and may use, for example, an F₂ laser having a wavelength of about 157 nm and EUV (Extreme ultraviolet) light having a wavelength of 20 nm or smaller.

The illumination optical system 801 is an optical system configured to illuminate a target surface by using a luminous flux emitted from the light source part 800, and this embodiment shapes a luminous flux into an exposure slit that is an optimal shape to the exposure, and illuminates the reticle 31. The illumination optical system 801 includes a lens, a mirror, an optical integrator, and a stop, etc. and arranges, for example, a condenser lens, a fly-eye lens, an aperture stop, a condenser lens, a slit, and an imaging optical system in this order. The illumination optical system 801 can use the light whether it is axial or off-axial. The optical integrator can include, a fly-eye lens, an integrator made by stacking two pairs of cylindrical lens arrays (or lenticular lenses), an optical rod, or a diffraction grating.

The reticle 31 uses, for instance, a quartz reticle. The reticle 21 has a circuit pattern to be transferred, and is supported and driven by the reticle stage RS. The diffracted light emitted from the reticle 31 passes the projection optical system 32, and is projected onto the wafer 6. The reticle 31 and the wafer 6 are arranged in an optically conjugate relationship. A pattern of the reticle 31 is transferred onto the wafer 6 by scanning the reticle 31 and the wafer 6 at a velocity ratio of a reduction magnification ratio. The exposure apparatus includes a light oblique incidence type reticle detection means (not shown), which detects a position of the reticle 31, and the reticle 31 is thus arranged in place.

The reticle stage RS supports the reticle 31 via a reticle chuck (not shown), and is connected to a moving mechanism (not shown). The moving mechanism includes a linear motor, and can move the reticle 31 by driving the reticle stage RS in each of the X-axis direction, the Y-axis direction, the Z-axis direction, and a rotational direction around each axis.

The projection optical system 32 serves to image a luminous flux from an object plane onto an image plane, and this embodiment images the diffracted light that has passed a pattern of the reticle 31, onto the wafer 6. The projection optical system 32 may use any one of a dioptric system, a catadioptric system, and a catoptric system. Alternatively, the projection optical system 32 may use an optical system that includes a plurality of lens elements and at least one diffraction optical element, such as a kinoform. When a correction of a chromatic aberration is necessary, a plurality of lens elements made of glass materials having different dispersion values (Abbe values) may be used, or a diffraction optical element is configured to disperse in a direction opposite to the lens element.

The substrate 6 as an object to be exposed is a wafer in this embodiment, and a photoresist is applied to its surface. In this embodiment, the wafer 6 is an object to be surface-measured by the focus control sensor 33 and the position measurement apparatus 200. Another embodiment replaces the wafer 6 with a liquid crystal substrate or another object to be exposed.

The wafer stage WS supports the wafer 6 via a wafer chuck (not shown). Similar to the reticle stage RS, the wafer stage WS uses a linear motor to move the wafer 6 in the X-axis direction, the Y-axis direction, the Z-axis direction, or a rotational direction around each axis. A position of the reticle stage RS and a position of the wafer stage WS are monitored, for example, by a six-axis laser interferometer 81, and the reticle stage RS and the wafer stage WS are driven at a constant velocity ratio. The wafer stage WS is provided on a stage stool supported on the floor, etc., via dampers. In addition, the reticle stage RS and the projection optical system 22 are provided, for example, a barrel stool (not shown) supported on a base frame via the dampers placed on the floor, etc.

Next follows a description of measurement points for the surface position (focus) of the wafer 6. This embodiment measures a wafer surface position by using the focus control sensor 33 while scanning the wafer stage WS in the scanning (or Y) direction over a whole area of the wafer 6. On the other hand, the wafer stage WS is stepped by ΔX in a (X) direction perpendicular to the scanning direction and then a surface position of the wafer is measured in the scanning direction; this procedure is repeated to measure a profile of the entire surface of the wafer 6. For a high throughput, a plurality of focus control sensors 33 may be used to simultaneously measure surface positions at different points on the wafer 6.

This focus control sensor 33 uses a system that optically measures a height. This embodiment uses a method of introducing a luminous flux to the surface of the wafer 6 at a high incident angle, and of detecting an image shift of the reflected light with a position detection element, such as a CCD. In particular, this embodiment introduces luminous fluxes to a plurality of measurement pints on the wafer 6, guides each luminous flux to an individual sensor, and calculates the tile of the surface to be exposed based on height measurement information at different positions.

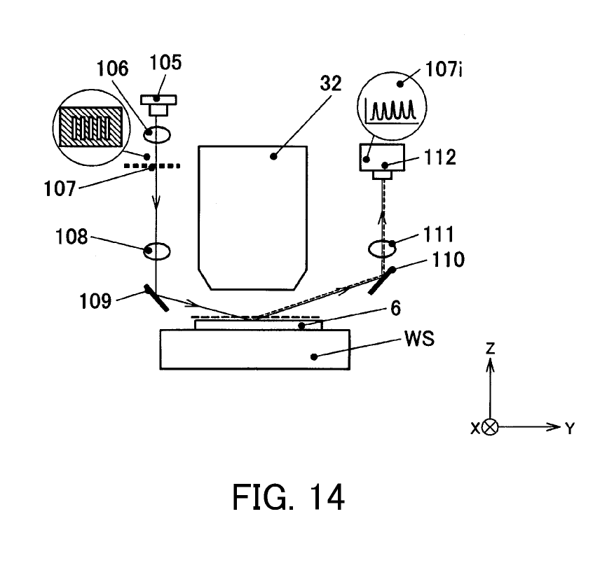

Next follows a detailed description of a focus/tilt detection system (focus control sensor 33). Initially, a description will be given of a structure and an operation of the focus control sensor 33. In FIG. 14, reference numeral 105 denotes a light source, reference numeral 106 denotes a condenser lens, reference 107 denotes a patterned board in which a plurality of rectangular transmission slits are arranged. Reference numerals 108 and 111 denote lenses, reference numeral 6 denotes a wafer. Reference numeral WS denotes a wafer stage. Reference numerals 109 and 110 denote mirrors. Reference numeral 112 denotes a light receiving element, such as a CCD. Reference numeral 32 denotes a reduction projection optical system configured to project an image of a reticle (not shown) onto a wafer 6. The light emitted from the light source 105 is condensed by the condenser lens 106, and illuminates the patterned board 107. The light that has transmitted through the patterned board 107 is irradiated onto the wafer 6 at a predetermined angle via the lens 108 and the mirror 109. The patterned board 107 and the wafer 6 have an imaging relationship with respect to the lens 108, and an aerial image of the slit of the patterned board 107 is formed on the wafer 6. The light reflected on the wafer 6 is received by the CCD 112 via the mirror 110 and the lens 111. A slit image of the wafer 6 is again imaged on the CCD 112 via the lens 111, and a signal, such as 107i of a slit image corresponding to each slit in the patterned board 107. A position of the wafer 6 in the Z direction can be measured by detecting a positional shift of this signal on the CCD 112. An optical-axis shift amount m1 on the wafer 6 when the surface of the wafer 6 changes by dZ from a position w1 to a position w2 in the Z direction can be expressed by the following equation where θin is an incident angle:

m1=2·dZ·tan θin EQUATION 2

For example, when the incident angle θin is set to 84°, m1=19×dZ is met, which corresponds to an enlarged displacement amount of the wafer's displacement by 19 times. The displacement amount on the light receiving element on the CCD 112 is a production between the above equation and the magnification of the optical system (or imaging magnification of the lens 111).

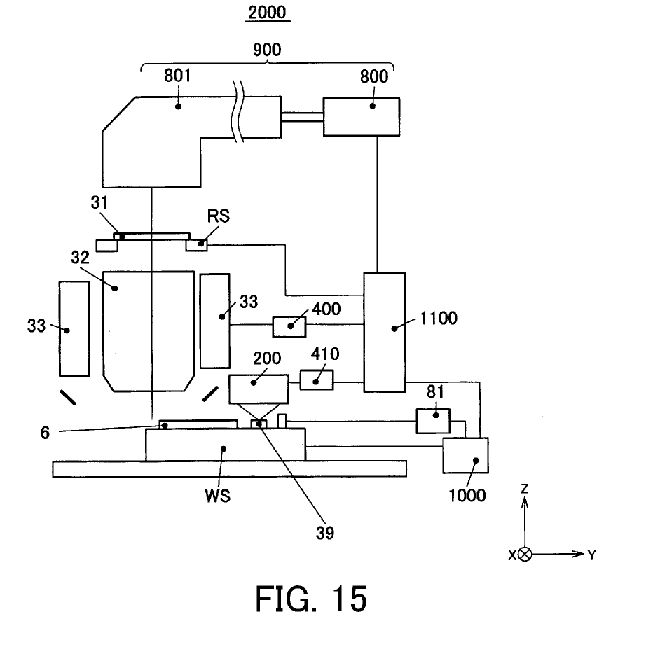

While the position measurement apparatus 200 in the above first to third embodiments are used to measure a position of the substrate 6, the present invention is not limited to this type. For example, as in FIG. 15, the position measurement apparatus 200 may be used for focusing of the stage reference mark of the reference plate 39 on the wafer stage WS.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-054950, filed Mar. 5, 2008, which is hereby incorporated by reference herein in its entirety.

What is claimed is:

1. A position measurement apparatus comprising:
a first beam splitter configured to split light from a light source into reference light and measurement light;
a reference mirror configured to receive the reference light;
a second beam splitter configured to synthesize the reference light reflected on the reference mirror with the measurement light that enters and is reflected on an object to be measured;
a photoelectric conversion element configured to detect an interference pattern caused by interference between the reference light and the measurement light that are synthesized;
a driving mechanism configured to drive the object to be measured, the position measurement apparatus being configured to drive the object to be measured through the driving mechanism, to detect the interference pattern through the photoelectric conversion element, and to calculate a surface position of the object to be measured based on a change of a detection signal obtained from the interference pattern; and
a selector configured to select a signal from an interference area between reflected measurement light and reflected reference light.

2. The position measurement apparatus according to claim 1, wherein the selector includes a slit board configured to limit a light receiving area of the photoelectric conversion element.

3. The position measurement apparatus according to claim 2, wherein the slit board has a variable opening width.

4. The position measurement apparatus according to claim 1, wherein the selector selects a detection effective area in the photoelectric conversion element.

5. The position measurement apparatus according to claim 1, wherein the photoelectric conversion element includes a one-dimensional image sensor.

6. The position measurement apparatus according to claim 1, wherein the light has a wavelength between 400 nm and 800 nm.

7. The position measurement apparatus according to claim 1, further comprising a controller configured to detect the interference area from a signal obtained by the photoelectric conversion element, and controls a selection by the selector based on a detection result of the interference area.

8. An exposure apparatus comprising a position measurement apparatus, wherein the position measurement apparatus includes:
a first beam splitter configured to split light from a light source into reference light and measurement light;
a reference mirror configured to receive the reference light;
a second beam splitter configured to synthesize the reference light reflected on the reference mirror with the measurement light that enters and is reflected on an object to be measured;
a photoelectric conversion element configured to detect an interference pattern caused by interference between the reference light and the measurement light that are synthesized;
a driving mechanism configured to drive the object to be measured, the position measurement apparatus being configured to drive the object to be measured through the driving mechanism, to detect the interference pattern through the photoelectric conversion element, and to calculate a surface position of the object to be measured based on a change of a detection signal obtained from the interference pattern; and
a selector configured to select a signal from an interference area between reflected measurement light and reflected reference light.

9. A position measurement method comprising the steps of:
splitting light from a light source into reference light and measurement light;
introducing the reference light to a reference mirror;
introducing the measurement light to an object to be measured;
synthesizing the reference light reflected on the reference mirror with the measurement light that enters and is reflected on the object to be measured;
detecting, via a photoelectric conversion element, an interference pattern caused by interference between the reference light and the measurement light that are synthesized while driving the object to be measured;
calculating a surface position of the object to be measured, based on a change of a detection signal obtained from the interference pattern; and
selecting a signal from an interference area between reflected measurement light and reflected reference light.
